(19) United States
(12) Patent Application Publication
(10) Pub. No.: US 2024/0075820 A1
(43) Pub. Date: Mar. 7, 2024

(54) NESTABLE CROSS-MEMBER BEAMS FOR TRACTION BATTERY PACKS

(71) Applicant: FORD GLOBAL TECHNOLOGIES, LLC, Detroit, MI (US)

(72) Inventors: Deanna Marie Winton Hoffman, Ann Arbor, MI (US); Patrick Daniel Maguire, Ann Arbor, MI (US); Brock Dunlap, Dearborn, MI (US); Michael E. Reibling, Sterling Heights, MI (US)

(21) Appl. No.: 18/105,447

(22) Filed: Feb. 3, 2023

Related U.S. Application Data
(60) Provisional application No. 63/403,445, filed on Sep. 2, 2022.

(51) Int. Cl. B60L 50/64; H01M 50/325; H01M 50/367

(52) U.S. Cl. CPC B60L 50/64; H01M 50/325; H01M 50/367; H01M 2220/20

(57) ABSTRACT

Nestable cross-member beams are provided for use within traction battery packs. A first cross-member beam of a first cell stack may nest together with a second cross-member beam of a second cell stack to establish a structural cross-member assembly between the first and second cell stacks at a location inside the traction battery pack. The structural cross-member assembly may include one or more venting passageways that facilitate the venting of battery cell vent byproducts to a location external to the traction battery pack during battery thermal events. The venting passageways may direct the vent byproducts through one or more valve assemblies provided within an enclosure assembly of the traction battery pack. The valve assemblies may direct the vent byproducts through one or more vehicle body components.

### CROSS-REFERENCE TO RELATED APPLICATIONS

This disclosure claims priority to U.S. Provisional Application No. 63/403,445, which was filed on Sep. 2, 2022 and is incorporated herein by reference.

### TECHNICAL FIELD

This disclosure relates generally to traction battery packs, and more particularly to nestable cross-member beams for establishing structural cross-member assemblies inside a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first cell stack, a second cell stack, and a cross-member assembly arranged between the first cell stack and the second cell stack. The cross-member assembly includes a first cross-member beam that nests together with a second cross-member beam to establish the cross-member assembly.

In a further non-limiting embodiment of the foregoing traction battery pack, the cross-member assembly includes a venting passageway disposed between the first cross-member beam and the second cross-member beam.

In a further non-limiting embodiment of either of the foregoing traction battery packs, a valve assembly is fluidly connected to the venting passageway.

In a further non-limiting embodiment of any of the foregoing traction battery packs, at least one of the first cross-member beam or the second cross-member beam includes a vent opening that is fluidly connected to the venting passageway.

In a further non-limiting embodiment of any of the foregoing traction battery packs, the first cell stack includes a plurality of battery cells stacked between the first cross-member beam and a third cross-member beam.

In a further non-limiting embodiment of any of the foregoing traction battery packs, the third cross-member beam includes an identical design as the second cross-member beam.

In a further non-limiting embodiment of any of the foregoing traction battery packs, the third cross-member is configured to interface with an enclosure assembly of the traction battery pack.

In a further non-limiting embodiment of any of the foregoing traction battery packs, the cross-member assembly includes a first venting passageway and a second venting passageway disposed between the first cross-member beam and the second cross-member beam.

In a further non-limiting embodiment of any of the foregoing traction battery packs, the second venting passageway is fluidly isolated from the first venting passageway by a dividing wall established by nesting side surfaces of the first cross-member beam and the second cross-member beam.

In a further non-limiting embodiment of any of the foregoing traction battery packs, a first valve assembly is fluidly connected to the first venting passageway, and a second valve assembly is fluidly connected to the second venting passageway.

In a further non-limiting embodiment of any of the foregoing traction battery packs, the first cross-member beam includes a side surface having a first stepped profile, and the second cross-member beam includes a side surface having a second stepped profile. The first stepped profile nests with the second stepped profile to establish a nesting interface between the first cross-member beam and the second cross-member beam.

In a further non-limiting embodiment of any of the foregoing traction battery packs, the first cross-member beam includes a first flange section and the second cross-member beam includes a second flange section. The first flange section overlaps the second flange section to establish a nesting interface between the first cross-member beam and the second cross-member beam.

In a further non-limiting embodiment of any of the foregoing traction battery packs, the first cross-member beam includes a first flange section and the second cross-member beam includes a second flange section. The first flange section abuts the second flange section to establish a nesting interface between the first cross-member beam and the second cross-member beam.

In a further non-limiting embodiment of any of the foregoing traction battery packs, the first cross-member beam includes a surface configured to interface with a component of the first cell stack.

In a further non-limiting embodiment of any of the foregoing traction battery packs, the component is a standoff located between a battery cell of the first cell stack and the first cross-member beam.

An electrified vehicle according to another exemplary aspect of the present disclosure includes, among other things, a vehicle body component, a traction battery pack mounted relative to the vehicle body component, a venting passageway provided by a cross-member assembly of the traction battery pack, and a valve assembly provided within an enclosure assembly of the traction battery pack and configured to establish a vent path between the venting passageway and the vehicle body component.

In a further non-limiting embodiment of the foregoing electrified vehicle, the vehicle body component is a rocker panel of the electrified vehicle.

In a further non-limiting embodiment of either of the foregoing electrified vehicles, the cross-member assembly includes a first cross-member beam that nests together with a second cross-member beam to establish the cross-member assembly.

In a further non-limiting embodiment of any of the foregoing electrified vehicles, at least one of the first cross-member beam or the second cross-member beam includes a vent opening that is fluidly connected to the venting passageway.

In a further non-limiting embodiment of any of the foregoing electrified vehicles, the valve assembly is mounted within a wall of an enclosure tray or an enclosure cover of the enclosure assembly.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates an exemplary cross-member assembly for a traction battery pack.

FIG. 4 schematically illustrates a method of assembling the cross-member assembly of FIG. 3.

FIG. 5 illustrates vent management features associated with a traction battery pack that is mounted to an underbody of an electrified vehicle.

FIG. 6 illustrates another exemplary cross-member assembly for a traction battery pack.

### DETAILED DESCRIPTION

This disclosure details nestable cross-member beams for use within traction battery packs. A first cross-member beam of a first cell stack may nest together with a second cross-member beam of a second cell stack to establish a structural cross-member assembly between the first and second cell stacks at a location inside the traction battery pack. The structural cross-member assembly may include one or more venting passageways that facilitate the venting of battery cell vent byproducts to a location external to the traction battery pack during battery thermal events. The venting passageways may direct the vent byproducts through one or more valve assemblies provided within an enclosure assembly of the traction battery pack. The valve assemblies may direct the vent byproducts through one or more vehicle body components. These and other features are discussed in greater detail in the following paragraphs of this detailed description.

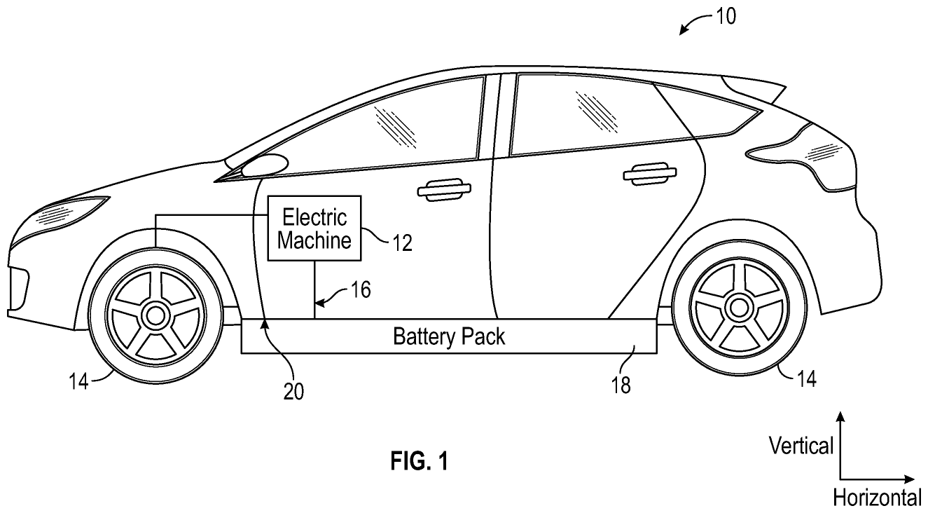

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

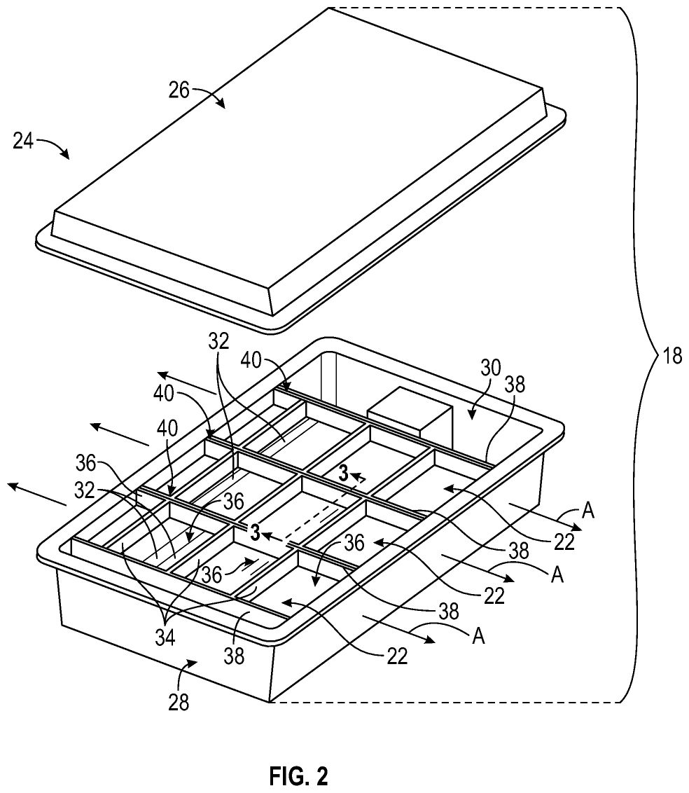

FIG. 2 illustrates additional details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cells stacks 22 and other battery internal components of the traction battery pack 18.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

One or more dividers 34 may be arranged along the respective cell stack axis A of each cell stack 22. The dividers 34 may compartmentalize each cell stack 22 into two or more groupings or compartments 36 of battery cells 32. In an embodiment, the dividers 34 establish thermal barriers between adjacent compartments 36 of battery cells 32.

Each compartment 36 may hold one or more of the battery cells 32 within one of the cell stacks 22. In an embodiment, the battery cells 32 of each cell stack 22 are held within one of four compartments 36. However, other configurations, including configurations that utilize a greater or fewer number of compartments 36, could be used within the scope of this disclosure.

The battery cells 32 of each cell stack 22 may be arranged between a pair of cross-member beams 38. The cross-member beams 38 may be configured to hold the battery cells 32 and at least partially delineate the cell stacks 22. The cross-member beams 38 may be made of a plastic material, a metallic material

The cross-member beams 38 may be adhesively secured to the enclosure cover 26 and to the enclosure tray 28 (or a heat exchanger plate, for example). The adhesive can seal these interfaces to inhibit battery cell vent byproducts from escaping through these areas.

Immediately adjacent cross-member beams 38 may established a cross-member assembly 40 disposed between adjacent cell stacks 22 of the traction battery pack 18. The cross-member assemblies 40 may be configured to transfer a load applied to a side of the electrified vehicle 10, for example. Each cross-member assembly 40 may therefore act as a structural subcomponent of the traction battery pack 18. Each cross-member beam 38 of the cross-member assemblies 40 may be a structural beam that can help accommodate tension loads from battery cell 32 expansion and compression loads. The cross-member assemblies 40 are therefore configured to increase the structural integrity of the traction battery pack 18.

In an embodiment, the cell stacks 22 and the cross-member assemblies 40 extend longitudinally in a cross-vehicle direction. However, other configurations are further contemplated within the scope of this disclosure.

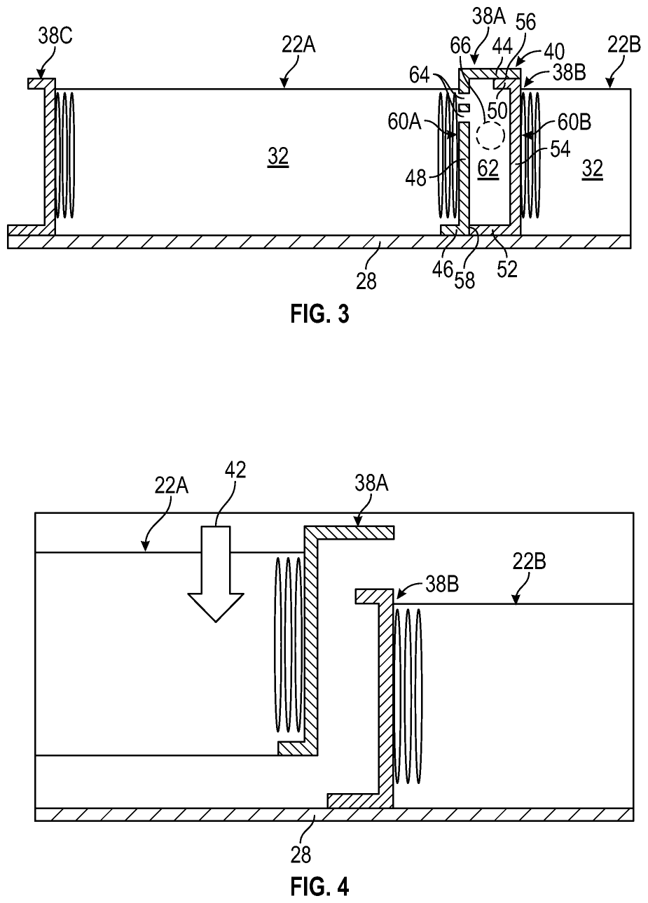

FIGS. 3 and 4, with continued reference to FIG. 2, illustrate an exemplary cross-member assembly 40 that may be implemented for use within the traction battery pack 18. The cross-member assembly 40 may include a first cross-member beam 38A and a second cross-member beam 38B. The first cross-member beam 38A may be part of a first cell stack 22A, and the second cross-member beam 38B may be part of a second cell stack 22B. The first cell stack 22A and the second cell stack 22B can be immediately adjacent cell stacks of the traction battery pack 18.

The first cross-member beam 38A may include a different cross-sectional configuration than the second cross-member beam 38B in order to configure the first and second cross-member beams 38A, 38B to interlock or nest together. In an embodiment, the first cross-member beam 38A may interlock or nest together with the second cross-member beam 38B as the first cell stack 22A is moved into place adjacent to the second cell stack 22B during assembly of the traction battery pack 18. For example, the first cell stack 22A may be moved in a direction 42 (see FIG. 4) toward the enclosure tray 28 until the first cross-member beam 38A nests together with the second cross-member beam 38B in the manner depicted in FIG. 3.

The first cross-member beam 38A may be a unitary, single-piece structure that includes an upper flange section 44, a lower flange section 46, and a mid-section 48 that extends between the upper flange section 44 and the lower flange section 46. Similarly, the second cross-member beam 38B may be a unitary, single-piece structure that includes an upper flange section 50, a lower flange section 52, and a mid-section 54 that extends between the upper flange section 50 and the lower flange section 52.

The upper flange section 44 of the first cross-member beam 38A may interface with the upper flange section 50 of the second cross-member beam 38B to establish a first nesting interface 56 of the cross-member assembly 40. In an embodiment, the upper flange section 44 overlaps the upper flange section 50 to establish the first nesting interface 56. However, other configurations are possible as would be understood by a person of ordinary skill in the art having the benefit of this disclosure.

The lower flange section 52 of the second cross-member beam 38B may interface with the lower flange section 46 of the first cross-member beam 38A to establish a second nesting interface 58 of the cross-member assembly 40. In an embodiment, the lower flange section 52 abuts against the lower flange section 46 to establish the second nesting interface 58. However, other configurations are possible as would be understood by a person of ordinary skill in the art having the benefit of this disclosure.

The first cross-member beam 38A and the second cross-member beam 38B may be bonded or otherwise secured together at each of the first nesting interface 56 and the second nesting interface 58. A structural adhesive may be utilized to secure the first cross-member beam 38A and the second cross-member beam 38B together for establishing the cross-member assembly 40, for example.

The mid-section 48 of the first cross-member beam 38A may be configured to interface with a component 60A of the first cell stack 22A. In an embodiment, the component 60A is a standoff located between the battery cells 32 and the first cross-member beam 38A of the first cell stack 22A. The standoffs may act as tensile members for maintaining battery cell expansion forces, for example. However, other configurations are possible.

The mid-section 54 of the second cross-member beam 38B may be configured to interface with a component 60B of the second cell stack 22B. In an embodiment, the component 60B is a standoff located between the battery cells 32 and the second cross-member beam 38B of the second cell stack 22B. The standoffs may act as tensile members for maintaining battery cell expansion forces, for example. However, other configurations are possible.

The first cell stack 22A may include a third cross-member beam 38C that can be identical in design to the second cross-member beam 38B of the second cell stack 22B. The third cross-member beam 38C may interface with a fourth cross-member beam (not shown) that includes an identical design as the first cross-member beam 38A to establish an additional cross-member assembly of the traction battery pack 18. Alternatively, the third cross-member beam 38C could be configured to interface with the enclosure assembly 24 of the traction battery pack 18. Each cell stack 22 of the traction battery pack 18 may therefore include a pair of cross-member beams, with one cross-member beam having the design of the first cross-member beam 38A and the other cross-member beam having the design of the second cross-member beam 38B.

The cross-member assembly 40 may establish a vent management system for expelling battery cell vent byproducts (e.g., gases and/or debris) from the traction battery pack 18 during battery thermal events. For example, the cross-member assembly 40 may establish a venting passageway 62 that can communicate battery cell vent byproducts released from one or more battery cells 32 of the first cell stack 22A and/or the second cell stack 22B toward a position where the battery cell vent byproducts can be expelled from the traction battery pack 18.

The venting passageway 62 may extend between the first cross-member beam 38A and the second cross-member beam 38B. For example, the upper flange section 44 of the first cross-member beam 38A and the upper flange section 50 of the second cross-member beam 38B may establish a vertically upper side of the venting passageway 62, the lower flange section 46 of the first cross-member beam 38A and the lower flange section 52 of the second cross-member beam 38B may establish a vertically lower side of the venting passageway 62, the mid-section 48 of the first cross-member beam 38A may establish a first side of the venting passageway 62, and the mid-section 54 of the second cross-member beam 38B may establish a second side of the venting passageway 62. Vertical and horizontal, for purposes of this disclosure, are with reference to ground and a general orientation of traction battery pack 18 when installed within the electrified vehicle 10 (see FIG. 1).

In an embodiment, the first cross-member beam 38A includes a plurality of vent openings 64 for communicating battery cell vent byproducts released by one or more battery cells 32 of the first cell stack 22A through the beam and into the venting passageway 62. However, the cross-member assembly 40 could be configured such that the first cell stack 22A, the second cell stack 22B, or both may vent into the venting passageway 62 during battery thermal events. The vent openings 64 provide a path for battery cell vent byproducts to move through the first cross-member beam 38A and into the venting passageway 62 as required during a venting event.

In an embodiment, the vent openings 64 are formed through the mid-section 48 of the first cross-member beam 38A. However, other configurations are also possible.

A flow of the battery cell vent byproducts can move within the venting passageway 62 along a length of the cross-member assembly 40 and, for example, through a valve assembly 66 in the enclosure assembly 24 to an area outside the traction battery pack 18. The valve assembly 66 may be received within a section (e.g., portion of the enclosure cover 26, the enclosure tray 28, or both) of the enclosure assembly 24 that is in axial alignment with the venting passageway 62 and is therefore fluidly connected to the venting passageway 62. The valve assembly 66 can therefore provide a venting path between the venting passageway 62 and the exterior of the traction battery pack 18. The valve assembly 66 may be a one-way valve that allows egress of battery cell vent byproducts while preventing ingress of air or other fluids or debris into the traction battery pack 18.

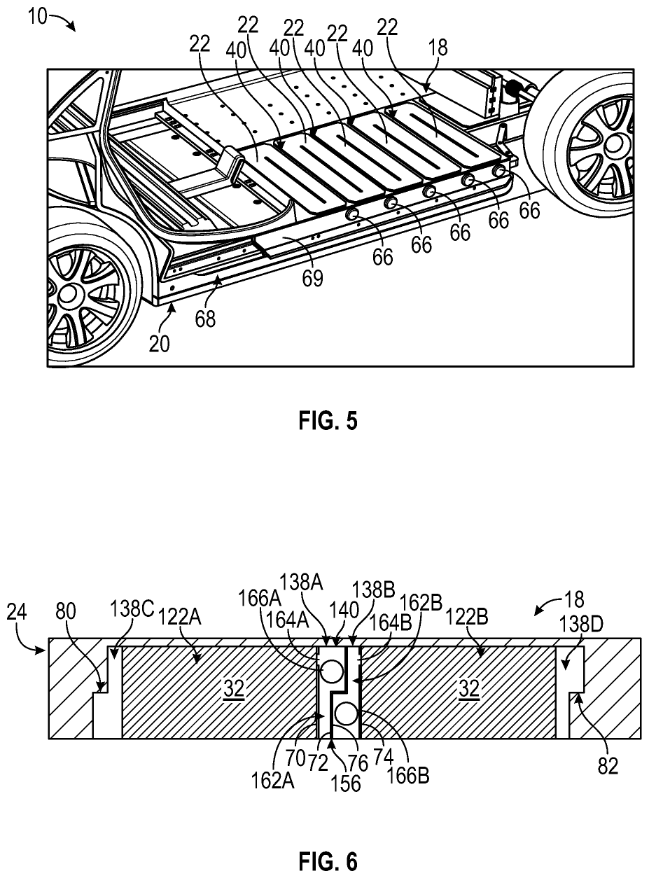

Referring now to FIG. 5 (with continued reference to FIGS. 3-4), the traction battery pack 18 may include a plurality of valve assemblies 66, with at least one valve assembly 66 being fluidly connected to each venting passageway 62 of each cross-member assembly 40. The traction battery pack 18 may be mounted relative to a vehicle body component 68 associated with the underbody 20 of the electrified vehicle 10. Each valve assembly 66 may be arranged such that battery cell vent byproducts expelled through each valve assembly 66 may vent into and then through an internal cavity 69 associated with the vehicle body component 68. The battery cell vent byproducts can therefore be effectively managed in the event of a battery thermal event.

In an embodiment, the vehicle body component 68 is a rocker panel of the electrified vehicle 10. However, other vehicle body components are contemplated within the scope of this disclosure.

FIG. 6 illustrates another exemplary cross-member assembly 140 that can be implemented for use within a traction battery pack, such as the traction battery pack 18 of FIGS. 1 and 2. The cross-member assembly 140 may include a first cross-member beam 138A and a second cross-member beam 138B. The first cross-member beam 138A may be part of a first cell stack 122A, and the second cross-member beam 138B may be part of a second cell stack 122B. The first cell stack 122A and the second cell stack 22B can be adjacent cell stacks housed within an enclosure assembly 24 of the traction battery pack 18.

The first cross-member beam 138A may include a different configuration than the second cross-member beam 138B in order to configure the first and second cross-member beams 138A, 138B to interlock or nest together. In an embodiment, the first cross-member beam 138A may nest together with the second cross-member beam 138B as the first cell stack 122A is moved into place adjacent to the second cell stack 122B during assembly of the traction battery pack 18.

The first cross-member beam 138A may be a unitary, single-piece structure that includes a first side surface 70 and a second side surface 72. Similarly, the second cross-member beam 138B may be a unitary, single-piece structure that includes a first side surface 74 and a second side surface 76.

The second side surface 72 of the first cross-member beam 138A may interface with the second side surface 76 of the second cross-member beam 138B to establish a nesting interface 156 of the cross-member assembly 140. The second side surface 72 and the second side surface 76 may each include a stepped profile. In an embodiment, the stepped profile of the second side surface 76 includes an inverse relationship relative to the stepped profile of the second side surface 72 in order to establish the nesting interface 156. However, other nesting configurations are possible as would be understood by a person of ordinary skill in the art having the benefit of this disclosure.

The first cross-member beam 138A and the second cross-member beam 138B may be bonded or otherwise secured together at the nesting interface 156. A structural adhesive may be utilized to secure the first cross-member beam 138A and the second cross-member beam 138B together for establishing the cross-member assembly 140.

The first side surface 70 of the first cross-member beam 138A may be configured to interface with a component(s) of the first cell stack 122A. The first side surface 70 may include a different profile than the stepped profile of the second side surface 72. In an embodiment, the first side surface 70 includes a substantially flat profile. However, other configurations are possible as would be understood by a person of ordinary skill in the art having the benefit of this disclosure.

The first side surface 74 of the second cross-member beam 138B may be configured to interface with a component(s) of the second cell stack 122B. The first side surface 74 may include a different profile than the stepped profile of the second side surface 76. In an embodiment, the first side surface 74 includes a substantially flat profile. However, other configurations are possible as would be understood by a person of ordinary skill in the art having the benefit of this disclosure.

The first cell stack 122A may further include a third cross-member beam 138C that is identical in design to the second cross-member beam 138B of the second cell stack 122B, and the second cell stack 122B may further include a fourth cross-member beam 138D that includes an identical design as the first cross-member beam 138A of the first cell stack 122A. Therefore, each cell stack 122A, 122B may include a pair of cross-member beams, with one cross-member beam having the design of the first cross-member beam 138A and the other cross-member beam having the design of the second cross-member beam 138B.

The third cross-member beam 138C may be configured to interface with a stepped section 80 of the enclosure assembly 24, and the fourth cross-member beam 138D may be configured to interface with a stepped section 82 of the enclosure assembly 24. The stepped sections 80, 82 may be part of an enclosure cover and/or an enclosure tray of the enclosure assembly 24.

The cross-member assembly 140 may establish a vent management system for expelling battery cell vent byproducts (e.g., gases and/or debris) from the traction battery pack 18 during battery thermal events. For example, the cross-member assembly 140 may establish a first venting passageway 162A that can communicate battery cell vent byproducts released from the first cell stack 122A and a second venting passageway 162B that can communicate battery cell vent byproducts released by the second cell stack 122B toward a position where the battery cell vent byproducts can be expelled from the traction battery pack 18. In this implementation, the second side surface 72 of the first cross-member beam 138A and the second side surface 76 of the second cross-member beam 138B cooperate to establish a dividing wall between the first venting passageway 162A and the second venting passageway 162B. The first venting passageway 162A and the second venting passageway 162B may thus be fluidly isolated from one another along the nesting interface 156.

The first cross-member beam 138A may include a plurality of vent openings 164A for communicating battery cell vent byproducts released by one or more battery cells 32 of the first cell stack 122A through the beam and into the first venting passageway 162A. Similarly, the second cross-member beam 138B may include a plurality of venting openings 164B for communicating battery cell vent byproducts released by one or more battery cells 32 of the second cell stack 122A through the beam and into the second venting passageway 162B. The vent openings 164A, 164B provide paths for battery cell vent byproducts to move through the first cross-member beam 138A and the second cross-member beam 138B and into the first and second venting passageways 162, 162B as may be required during a venting event.

A flow of the battery cell vent byproducts can move within the venting passageways 162A, 162B along a length of the cross-member assembly 140 and, for example, through either a valve assembly 166A or a valve assembly 166B provided in the enclosure assembly 24 to an area outside the traction battery pack 18. The valve assembly 166A may be received within a section (e.g., portion of the enclosure cover, the enclosure tray, or both) of the enclosure assembly 24 that is in axial alignment with the first venting passageway 162A and is therefore fluidly connected to the first venting passageway 162A. The valve assembly 166B may be received within a section (e.g., portion of the enclosure cover, the enclosure tray, or both) of the enclosure assembly 24 that is in axial alignment with the second venting passageway 162B and is therefore fluidly connected to the second venting passageway 162B. The valve assemblies 166A, 166B can therefore provide respective venting paths between each venting passageway 162A, 162B and the exterior of the traction battery pack 18. The valve assemblies 166A, 166B may be one-way valves that allows egress of battery cell vent byproducts while preventing ingress of air or other fluids or debris into the traction battery pack 18.

The nestable cross-member beams of this disclosure are capable of establishing structural cross-member assemblies inside a traction battery pack. The cross-member beams may further incorporate features for facilitating the venting of battery cell vent byproducts during battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first cell stack;
a second cell stack;
a cross-member assembly arranged between the first cell stack and the second cell stack; and
the cross-member assembly including a first cross-member beam that nests together with a second cross-member beam to establish the cross-member assembly.

2. The traction battery pack as recited in claim 1, wherein the cross-member assembly includes a venting passageway disposed between the first cross-member beam and the second cross-member beam.

3. The traction battery pack as recited in claim 2, comprising a valve assembly fluidly connected to the venting passageway.

4. The traction battery pack as recited in claim 2, wherein at least one of the first cross-member beam or the second cross-member beam includes a vent opening that is fluidly connected to the venting passageway.

5. The traction battery pack as recited in claim 1, wherein the first cell stack includes a plurality of battery cells stacked between the first cross-member beam and a third cross-member beam.

6. The traction battery pack as recited in claim 5, wherein the third cross-member beam includes an identical design as the second cross-member beam.

7. The traction battery pack as recited in claim 5, wherein the third cross-member is configured to interface with an enclosure assembly of the traction battery pack.

8. The traction battery pack as recited in claim 1, wherein the cross-member assembly includes a first venting passageway and a second venting passageway disposed between the first cross-member beam and the second cross-member beam.

9. The traction battery pack as recited in claim 8, wherein the second venting passageway is fluidly isolated from the first venting passageway by a dividing wall established by nesting side surfaces of the first cross-member beam and the second cross-member beam.

10. The traction battery pack as recited in claim 9, comprising a first valve assembly fluidly connected to the first venting passageway and a second valve assembly fluidly connected to the second venting passageway.

11. The traction battery pack as recited in claim 1, wherein the first cross-member beam includes a side surface having a first stepped profile, and the second cross-member beam includes a side surface having a second stepped profile, wherein the first stepped profile nests with the second stepped profile to establish a nesting interface between the first cross-member beam and the second cross-member beam.

12. The traction battery pack as recited in claim 1, wherein the first cross-member beam includes a first flange section and the second cross-member beam includes a second flange section, wherein the first flange section overlaps the second flange section to establish a nesting interface between the first cross-member beam and the second cross-member beam.

13. The traction battery pack as recited in claim 1, wherein the first cross-member beam includes a first flange section and the second cross-member beam includes a second flange section, wherein the first flange section abuts the second flange section to establish a nesting interface between the first cross-member beam and the second cross-member beam.

14. The traction battery pack as recited in claim 1, wherein the first cross-member beam includes a surface configured to interface with a component of the first cell stack.

15. The traction battery pack as recited in claim 14, wherein the component is a standoff located between a battery cell of the first cell stack and the first cross-member beam.

16. An electrified vehicle, comprising:
a vehicle body component;
a traction battery pack mounted relative to the vehicle body component;
a venting passageway provided by a cross-member assembly of the traction battery pack; and
a valve assembly provided within an enclosure assembly of the traction battery pack and configured to establish a vent path between the venting passageway and the vehicle body component.

17. The electrified vehicle as recited in claim 16, wherein the vehicle body component is a rocker panel of the electrified vehicle.

18. The electrified vehicle as recited in claim 16, wherein the cross-member assembly includes a first cross-member beam that nests together with a second cross-member beam to establish the cross-member assembly.

19. The electrified vehicle as recited in claim 18, wherein at least one of the first cross-member beam or the second cross-member beam includes a vent opening that is fluidly connected to the venting passageway.

20. The electrified vehicle as recited in claim 16, wherein the valve assembly is mounted within a wall of an enclosure tray or an enclosure cover of the enclosure assembly.
